(19) United States
(12) Patent Application Publication
(10) Pub. No.: US 2026/0364909 A1
(43) Pub. Date: Nov. 19, 2026

(54) INSTALLATION AND METHOD FOR MANUFACTURING GREEN TIRES

(71) Applicant: COMPAGNIE GENERALE DES ETABLISSEMENTS MICHELIN, Clermont-Ferrand (FR)

(72) Inventors: NICOLAS BARD, Clermont-Ferrand (FR); QUENTIN DENIAU, Clermont-Ferrand (FR); MICHEL DRUET, Clermont-Ferrand (FR); NICOLAS ROCA-FILELLA, Clermont-Ferrand (FR); ETIENNE THOMANN, Clermont-Ferrand (FR)

(21) Appl. No.: 19/137,588

(22) PCT Filed: Nov. 20, 2023
(86) PCT No.: PCT/FR2023/051823

§ 371 Date: Jun. 10, 2025

(30) Foreign Application Priority Data
Dec. 14, 2022 (FR) FR2213318

(51) Int. Cl. B29D 30/30; B29D 30/28

(52) U.S. Cl. CPC B29D 30/3007; B29D 30/28; B29D 2030/3064

(57) ABSTRACT

A facility for manufacturing (10) green tires comprises a rotatable drum (16), a platform (21) arranged upstream of the drum (16) and comprising a flat receiving surface (21a) for receiving an end of an elastomeric element, at least one robotic arm (18) configured to grip the end portion of the elastomeric element from above and comprising at least three rows of magnetic elements, and an ECU (40) configured to operate the robotic arm (18), and at least a first 3D camera configured to acquire an image of the end portion of the elastomeric element on the platform (21). The ECU (40) comprises at least a gripping module (50) for gripping the end portion of the elastomeric element on the basis of the point cloud rendered by the first camera and an anchoring module for anchoring the end on the outer surface (16a) of the drum (16).

The present invention relates to the field of tyre manufacturing and more particularly relates to a method for manufacturing green tyres and to a facility for carrying out such a method.

A tyre of a wheel of a motor vehicle generally comprises three distinct zones comprising a crown which comprises a crown reinforcement and a tread intended to come into contact with the ground, beads intended to attach the tyre to a rim of a wheel and sidewalls intended to connect the crown to the bead.

The tyre further comprises a metal or textile fibre structure forming a carcass for reinforcing the structure of the tyre and allowing the crown to be connected to the beads.

The manufacture of a green tyre involves the successive assembly of elements in the form of bead wires, strips or plies so as to form a carcass reinforcement of cylindrical shape. The cylindrical carcass reinforcement is then turned into a toroidal carcass reinforcement, in a step known as “building”. In this step, the crown of the cylindrical carcass reinforcement is stretched in such a way as to increase the diameter and the beads are moved axially towards one another. Lastly, elements in the form of strips or plies are assembled successively on the crown of the carcass reinforcement in such a way as to form a crown reinforcement and a tread on top.

The assembly and building steps are generally carried out on a drum for manufacturing green tyres of cylindrical shape, which is rotatable about an axis of symmetry of revolution. The elements in the form of threads, strips or plies are laid circumferentially on the drum or on the green tyre being manufactured. The laying steps are performed manually or automatically.

When the laying steps are performed manually, an operator located facing the drum grips the end portion of an element, for example, a ply wound on a spool, pulls it to the drum, positions it and secures it to the drum or to the green tyre being manufactured. The drum is then rotated so as to perform a complete revolution. During rotation of the drum, the operator guides the ply such that the winding of the ply substantially forms a right cylinder. The operator then cuts the ply, and adjusts the join between the two ends of the ply.

However, performing the laying step manually has many disadvantages. The operator is limited in terms of speed and accuracy. Getting close to or exceeding these limits moreover makes the work more tedious and more mentally tiring for the operator, which can be detrimental to the quality of the green tyres manufactured, or even the operator's safety.

On the other hand, automation of the laying steps as performed manually poses technical problems, in particular the design of a manufacturing machine capable of implementing said laying steps and, above all, the programming of said machine to be able to execute said laying steps.

Machines for manufacturing green tyres are known in which a drum is movable by means of a carriage or a robotic arm between a plurality of laying stations. Each laying station is adapted to lay a particular element such as a bead wire or a strip. Since the production rate of each station is not the same, the faster laying stations are not fully utilized, at the expense of their efficiency. In addition, the design, manufacture and operation of such an assembly machine are very complex and expensive.

Also known are machines for manufacturing green tyres comprising only two laying stations, each station being adapted to lay a set of preassembled elements. Thus, two complete revolutions of the drum are sufficient to lay a first set intended to constitute a carcass reinforcement and a second set intended to constitute a crown reinforcement and a tread. However, such a manufacturing machine requires that the architecture and the composition of the green tyre be themselves adapted, which significantly restricts the tyre design and industrialization process.

Document FR-B1-3 116 227, which proposes the automatic laying of an elastomeric element on a drum for manufacturing green tyres, comprising a predetermined sequence of steps of gripping the elastomeric element and pulling it towards the drum by means of a robotic arm comprising an effector, is also known. However, this document proposes a collaborative robotic arm, in other words a robotic arm in collaboration with an operator who manually performs a step of the sequence after an interruption step.

Furthermore, this document does not describe how the laying step is performed.

To be specific, the mechanical reinforcement of an elastomeric element coupled with the fact that said element is wound around a spool give rise to an end surface which is not completely flat after being unwound with a view to being laid on the outer surface of the drum. In addition, the stiffness of the element may influence the transverse position of its end unwound on a flat surface. In other words, the transverse position of the tip of the unwound elastomeric element may be angularly offset from an axial axis perpendicular to the axis of rotation of the drum.

There is thus a need to overcome the aforementioned disadvantages and automate machines for manufacturing green tyres while improving the laying of the elastomeric element and maintaining satisfactory reliability and productivity.

The invention aims to improve the laying of the elastomeric element, and in particular the gripping of the elastomeric element upstream of the drum, and the anchoring of said elastomeric element on said drum.

The invention also aims to improve the cutting of the elastomeric element.

The present invention relates to a facility for manufacturing green tyres associated with a first orthogonal reference frame and comprising a drum for manufacturing green tyres that is rotatable about an axis of rotation of the first reference frame, a platform arranged upstream of the drum, extending along a transverse axis of the first reference frame and comprising a flat receiving surface for receiving an end portion of an elastomeric element or ply, at least one robotic arm and an electronic control unit, ECU, configured to operate the robotic arm.

The facility further comprises at least a first three-dimensional camera rendering a point cloud of coordinates measured in a reference frame associated with said first camera and having a line of sight oriented toward the platform and configured to acquire an image of the end portion of the elastomeric element on the platform.

The robotic arm comprises at least one gripper associated with a second orthogonal reference frame distinct from the first reference frame and configured to grip the end portion of the elastomeric element from above.

Said gripper comprises at least three rows of magnetic elements or magnets that are parallel to one another and spaced apart from one another regularly along an axis of extension of the second reference frame.

The ECU comprises at least:
a gripping module for gripping the end portion of the elastomeric element, configured to determine a gripping point of the gripper on the basis of the point cloud rendered by the first camera, and
an anchoring module for anchoring said end portion on the outer surface of the drum, configured to determine an anchoring point of each of the rows of magnetic elements on the outer surface of the drum.

As a result, the assembly facility is agile, unlike the multi-station automatic assembly machines of the prior art in which each station is dedicated to the laying of a particular element or preassembled set.

Moreover, the robotic arm is more accurate than an operator, while being faster, thereby improving the quality of the green tyres manufactured, and increasing the useful time of operation of the manufacturing facility. The term “useful time” means the net time not including the time related to the manufacture of green tyres which are unsatisfactory in terms of quality. The term “net time” means the time during which the machine is manufacturing green tyres, not including the time related to lulls in production rate or breakdowns.

The tip of the elastomeric element or ply corresponds to the end of the end portion, for example triangular, of the elastomeric element. In other words, the tip corresponds to the vertex or peak of said end portion.

For example, said end portion extends along the axis of extension of the second reference frame angularly offset from the transverse axis of the first reference frame.

The angle of angular offset between the axis of extension of the second reference frame and the transverse axis of the first reference frame is preferably non-zero.

Advantageously, the gripping module comprises:
an acquisition module for acquisition of the image of the end portion of the elastomeric element on the platform by the first camera,
a splitting module for splitting the image of the end portion of the elastomeric element on the platform into three zones, and
a determination module for determining the position of the gripper and in particular of the gripping point, comprising a first image processor configured to determine an initial gripping point in the point cloud of the image from the acquisition module and to correct said initial gripping point by translating said initial gripping point by a distance corresponding to the radius of the magnets of the gripper along the axis of extension of the second reference frame and along a second longitudinal axis of the second reference frame perpendicular to said axis of extension and to determine the gripping point transmitted to the robotic arm by a transmission module.

Such translation makes it possible to increase the surface area of the gripper for magnetization with the end portion of the elastomeric element.

The three zones of the visible end portion on the platform comprise a first zone corresponding to the zone between the tip or peak of the end portion and a second zone, the second zone is located between the first zone and a third zone, and the third zone is located between the second zone and the edge of the platform.

The total length of the end portion of the elastomeric element corresponds to the distance between the tip of said end portion and the edge of the platform.

Preferably, the first and third zones each correspond to 30% of the total length. Alternatively, the length of the first zone could be different to the length of the third zone. For example, the length of the first zone could be between 20% and 30% of the total length and the length of the third zone could be between 20% and 30% of the total length.

According to an embodiment, the determination module for determining the position of the gripper is configured to determine a straight line passing through the lateral side of the second zone, the gripping point being axially offset from the tip of the end portion by a distance.

According to an embodiment, the facility comprises a first fixed vertical laser indicating the centre of the drum, a second fixed horizontal laser indicating the azimuth of laying of the elastomeric element and two variable vertical lateral lasers indicating the longitude of laying, said lasers being rigidly secured to a fixed structure or gantry of the facility. The anchoring module comprises a module for projecting said lasers onto the outer surface of the drum, and in particular onto a zone of laying of the end of the elastomeric element.

For example, the facility comprises a second three-dimensional camera rendering a point cloud of coordinates measured in a reference frame associated with said second camera and having a line of sight oriented towards the drum and configured to acquire an image of a laying zone on the outer surface of the drum.

The anchoring module comprises:
an acquisition module for acquisition of an image of said laying zone by said second camera, and
a module for processing the image of said laying zone, configured to detect the lasers and an intersection pixel at the intersection between the second horizontal laser and one of the lateral lasers, namely the right lateral laser if the end portion of the elastomeric element is oriented to the right or the left lateral laser if the end portion is oriented to the left, and a middle pixel at the intersection of the first horizontal vertical laser and the second horizontal laser, so as to estimate an intersection point and a middle point corresponding to the three-dimensional points of the intersection pixel and the middle pixel of the drum.

Advantageously, the anchoring module comprises:
a module configured to determine the anchoring point of each of the magnets with respect to the intersection point in a plane of normal where a circle fit on the point cloud of one of the lateral lasers is located and as a function of a distance between two rows of magnets and the radius of a magnet,
a module for transmitting said anchoring points to a control module for controlling the gripper, said control module being configured to separately control the rows of magnets of the gripper, and in particular the actuators of each magnet.

For example, the ECU comprises a support module for supporting the elastomeric element around the drum, a cutting module for cutting the elastomeric element to the desired length, and a welding module for welding the cut portion of the elastomeric element with the end portion anchored on the outer surface of the drum.

According to an embodiment, the gripper of the robotic arm comprises actuators each connected to a magnet, said actuators being separately controlled to successively release the third row of magnets, the second row of magnets and then the first row of magnets.

When the end portion of the elastomeric element is being anchored on the drum, it is preferable that the actuators be deactivated row by row to release the anchored zones of the elastomeric element.

The anchoring module makes it possible to anchor a product of complex shape on a rounded shape, i.e. the drum, by determining three anchoring points belonging to the same circle.

The magnetic elements of the gripper of the robotic arm are preferably mounted on a holder configured to be connected to the end portion of the one or more robotic arms in the case where there are two robotic arms.

According to an embodiment, the first, second and third rows of magnetic elements each comprise at least one magnetic element.

According to another embodiment, the first and second rows of magnetic elements of the gripper of the robotic arm each comprise a single magnetic element.

For example, the third row comprises at least three magnetic elements or magnets, one of the magnetic elements of the third row being aligned along the axis of extension with the magnetic elements of the first and second rows.

For example, the set of magnetic elements is arranged in such a way as to form a T.

In general, the shape of the gripper is symmetrical.

By virtue of the symmetrical arrangement of the gripper, it is possible to use the same gripper to grip the end portion of an elastomeric element oriented to the right or the end portion of an elastomeric element oriented to the left.

Alternatively, provision could be made for the gripper to comprise a different number of magnetic elements, for example greater than or equal to six.

The magnetic elements may have a circular or rectangular section or any other section.

According to an embodiment, the facility comprises a second robotic arm. For the gripping and anchoring steps, a single robot arm is required. However, the presence of a second robotic arm makes it possible to grip the end of the end portion of an elastomeric element oriented in the second direction. The second robotic arm is also used in the cutting step to hold the end portion against the drum.

For example, the first 3D camera, for example an RGB-D sensor, is fixed, and directed upstream towards the platform and attached to the fixed structure or gantry.

The first 3D camera is advantageously used for the laying and gripping steps.

The first 3D camera makes it possible to avoid the recalibration which is necessary when a 2D camera is used. To be specific, the first 3D camera will immediately match up the distance of the object and its perceived size, thereby making it possible to measure the dimensions of the object without having to indicate the depth at which it is with respect to the camera.

For example, the second 3D camera, for example an RGB-D sensor, is fixed, and directed towards the drum, and in particular attached to the fixed structure or gantry.

The second 3D camera is advantageously used for the anchoring, cutting and welding steps.

The RGB-D 3D camera is advantageously calibrated or standardized only relative to the robotic arm, and not to the environment, since said camera detects the environment in three dimensions and can allow measurement and determination of the positions and orientations of the elements in its field of view, which allows the platform to be oriented in different orientations. In other words, it is the 3D camera that will adapt to the orientation of the platform.

In the event that there are two robotic arms, the two RGB-D 3D cameras are advantageously calibrated or standardized only relative to the two robotic arms.

According to an embodiment, the platform comprises at least one plate or strip that is made of magnetic material or magnetized, extending along a longitudinal axis parallel to the axis of rotation and arranged on the receiving surface of the platform.

The magnetized strip makes it possible to attract the threads of the elastomeric element having magnetic properties and thus to press the end portion of said element on the platform. Alternatively, provision could be made for the platform not to comprise such a magnetized strip.

According to a second aspect, the invention relates to a method for the automatic and successive laying of elastomeric elements by means of a facility for manufacturing green tyres associated with a first orthogonal reference frame and comprising a drum for manufacturing green tyres that is rotatable about an axis, a platform arranged upstream of the drum, extending along a transverse axis of the first reference frame and comprising a flat receiving surface for receiving an end of an elastomeric element, at least one robotic arm provided, and at least a first three-dimensional camera rendering a point cloud of coordinates measured in a reference frame associated with said first camera and having a line of sight oriented towards the platform and configured to acquire an image of the end portion of the elastomeric element on the platform, in particular on the flat receiving surface.

The robotic arm comprises at least one gripper associated with a second orthogonal reference frame distinct from the first reference frame and configured to grip the end portion of the elastomeric element from above.

Said gripper comprises at least three rows of magnetic elements or magnets that are parallel to one another and spaced apart from one another regularly along an axis of extension of the second reference frame.

The method comprises at least one laying step comprising a sequence comprising at least:
a step of gripping the end portion of the elastomeric element, during which a gripping point of the gripper is determined on the basis of the point cloud rendered by the first camera, and
a step of anchoring said end on the outer surface of the drum, during which an anchoring point of each of the rows of magnetic elements on the outer surface of the drum is determined.

Thus, in the anchoring step, a contact pressure is applied and the portions of the end portion anchored on the drum are released gradually.

For example, said end portion extends along an axis of extension of the second reference frame angularly offset from the transverse axis of the first reference frame.

Advantageously, the step of gripping the end portion of the elastomeric element comprises a step of acquisition of the image of the end portion of the elastomeric element on the platform by the first camera, a step of splitting the image of the end portion of the elastomeric element on the platform into three zones, a step of determining the position of the gripper, in particular of an initial gripping point, in the point cloud of the image acquired in the acquisition step by means of a processor, a step of correcting the initial gripping point by translating the initial gripping point by a distance corresponding to the radius of each of the magnets of the gripper along the axis of extension of the second reference frame and along a second longitudinal axis of the second reference frame perpendicular to said axis of extension parallel to the axis of rotation and the transverse axis to obtain the gripping point, and a step of transmitting said gripping point to the robotic arm for the purpose of gripping of the end portion of the elastomeric element by the gripper.

Advantageously, the anchoring step comprises a step of projecting lasers and a step of acquisition of an image of a laying surface on the outer surface of the drum by a second camera, for example an RGB-D sensor, rendering a point cloud of coordinates measured in a reference frame associated with said second camera and having a line of sight oriented towards the drum, said steps of projecting lasers and acquisition of an image being carried out before the step of gripping of the end portion of the elastomeric element by the gripper.

The lasers comprise a first fixed vertical laser indicating the centre of the drum, a second fixed horizontal laser indicating the azimuth of laying of the elastomeric elements and two variable vertical lateral lasers indicating the longitude of laying, in order to anticipate the trajectory of the robotic arm and know where to anchor said end.

For example, the anchoring step further comprises:
a step of processing the image of the laying zone, during which the lasers and a point cloud rendered by the second camera are detected, the pixels associated with the lasers are isolated in the image acquired during the acquisition step, and the intersection pixel at the intersection between the second horizontal laser and one of the lateral lasers is detected,
a step of determining the anchoring point of each of the rows of magnets with respect to the intersection point in a plane of normal where a circle fit on the point cloud of one of the lateral lasers is located and as a function of a distance between two rows of magnets and the radius of a magnet of the gripper, and
a step of transmitting the anchoring points of each of the magnets to a control module for controlling the gripper, configured to separately control the rows of magnets of the gripper, and in particular the actuators of each magnet.

Advantageously, prior to the laying step, the method comprises an elastomeric element feed step during which the end portion of the elastomeric element is laid on the surface of a platform of the facility.

According to an embodiment, the sequence of the laying step further comprises a step of supporting the elastomeric element around the drum, a step of cutting the elastomeric element to the desired length, and a step of welding the cut portion of the elastomeric element with the end portion anchored on the outer surface of the drum.

Other aims, features and advantages of the invention will become apparent on reading the following description, provided solely by way of non-limiting example and with reference to the appended drawings, in which:

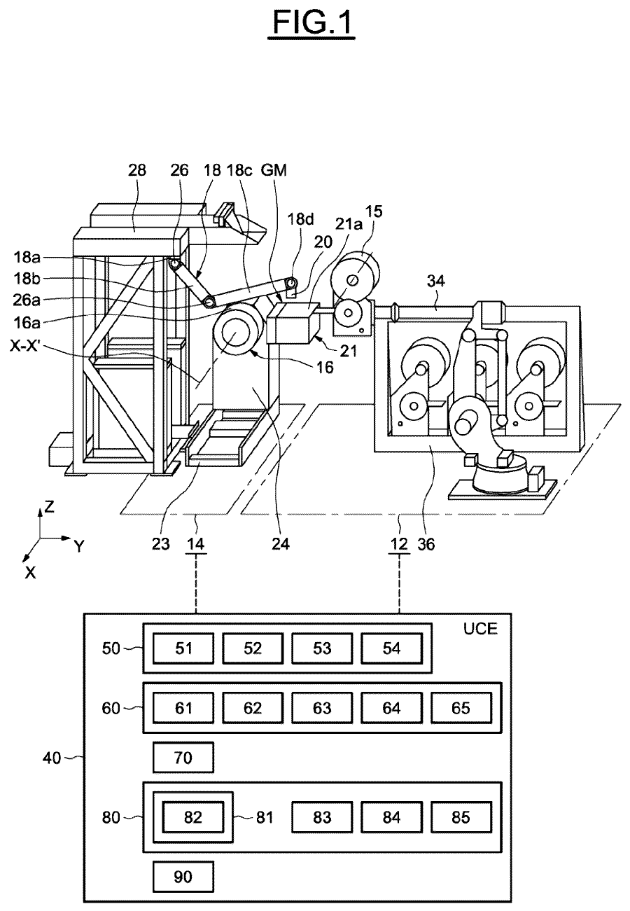

FIG. 1 shows, very schematically, an overall view of a green tyre manufacturing facility implementing a method for manufacturing green tyres according to the invention;

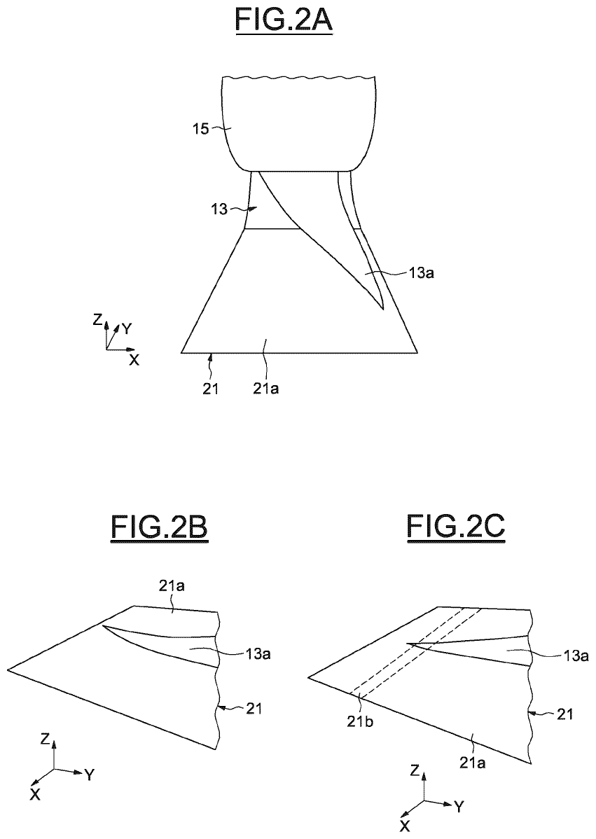

FIG. 2A, FIG. 2B, FIG. 2C depict in detail the position of the end portion of the elastomeric element on the platform of the facility of FIG. 1;

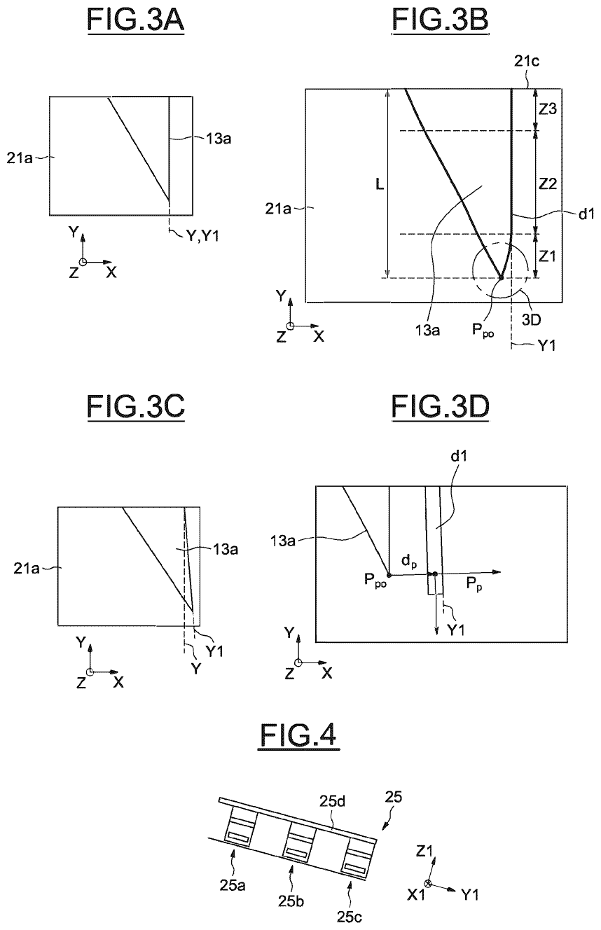

FIG. 3A, FIG. 3B, FIG. 3C depict various angular positions of the end portion of the elastomeric element with respect to the transverse axis;

FIG. 3D shows a detail of FIG. 3B;

FIG. 4 partially depicts the gripper of the facility of FIG. 1;

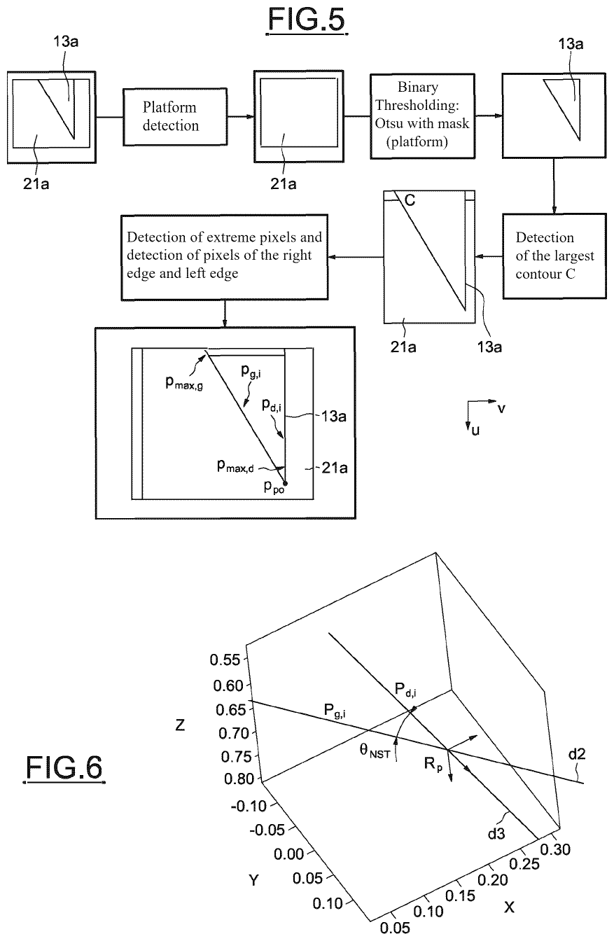

FIG. 5 depicts the steps of image processing by the image processor of the facility of FIG. 1;

FIG. 6 schematically depicts a three-dimensional representation from the first RGB-D camera;

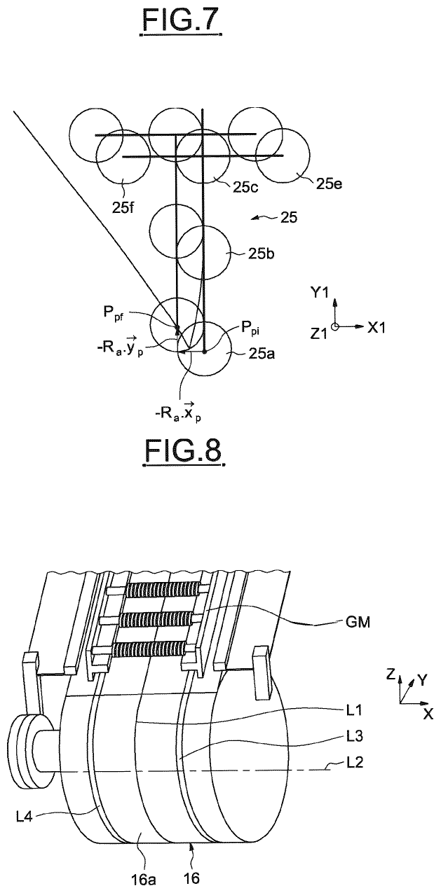

FIG. 7 depicts the translation of a gripping point of the end portion of the elastomeric element by the radius of a magnet of a gripper;

FIG. 8 schematically depicts the image acquired, by the second camera, of the outer surface of the drum of the facility of FIG. 1;

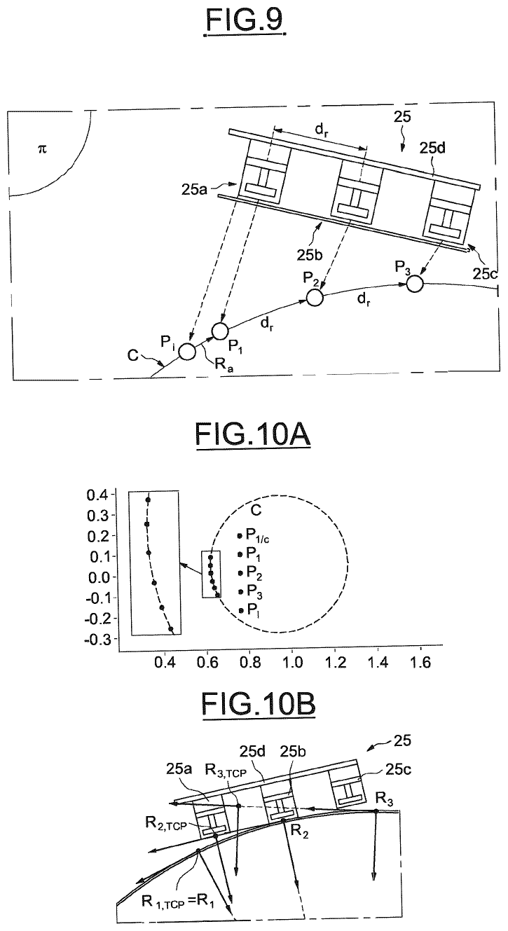

FIG. 9 depicts the position of the anchoring points P₁, P₂, P₃ of each of the magnets of the gripper with respect to the intersection point P₁ in a plane Pi (π) of normal \hat{n}_{π};

FIG. 10A depicts the circle fit on the point cloud of the laser;

FIG. 10B depicts the anchoring points of the magnets of the gripper;

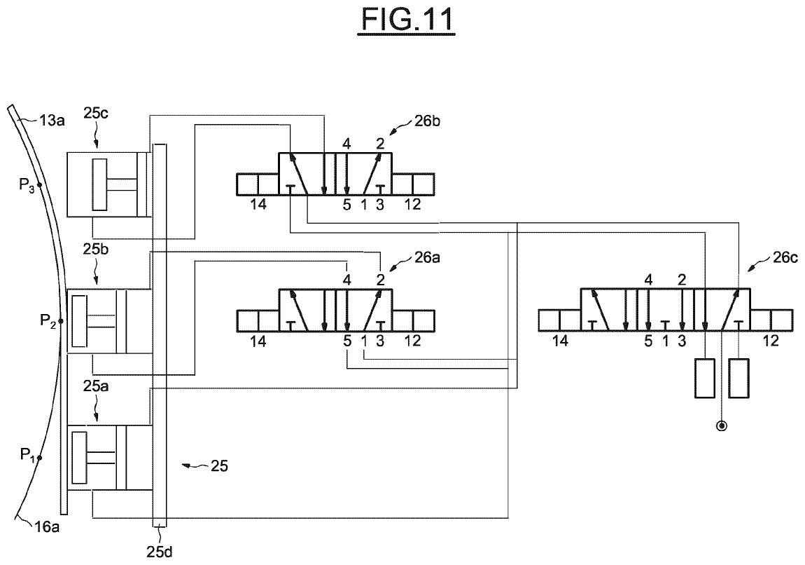

FIG. 11 depicts an example of a pneumatic diagram of control of the actuators of the magnets of the gripper;

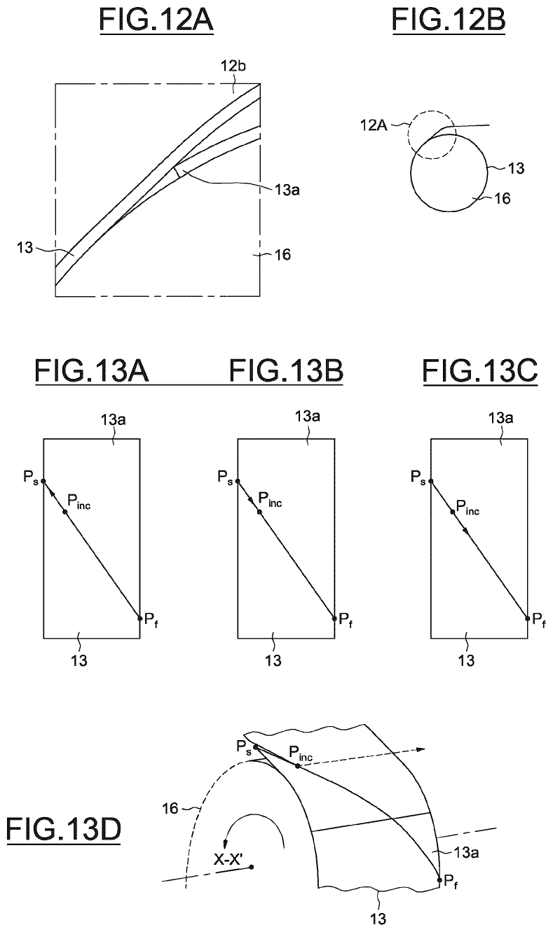

FIG. 12A, FIG. 12B depict the elastomeric element wound around the drum over a 3600 revolution;

FIG. 13A, FIG. 13B, FIG. 13C, FIG. 13D show the successive steps of cutting the elastomeric element;

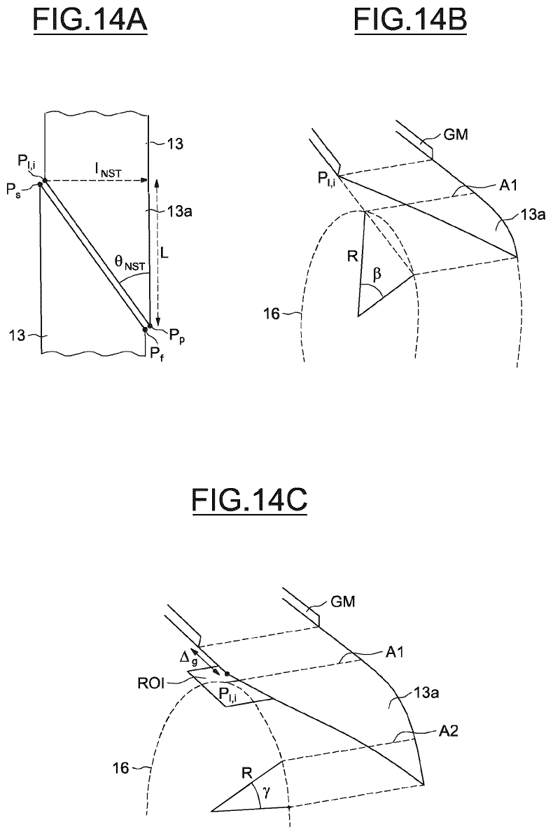

FIG. 14A depicts the exit point P_{S} of the cut when the elastomeric element is cut and its surface wound on the surface of the drum;

FIG. 14B shows the position of the elastomeric element at the end of anchoring of the end portion of the elastomeric element on the drum;

FIG. 14C depicts a region of interest ROI in which the incision point is made upon cutting;

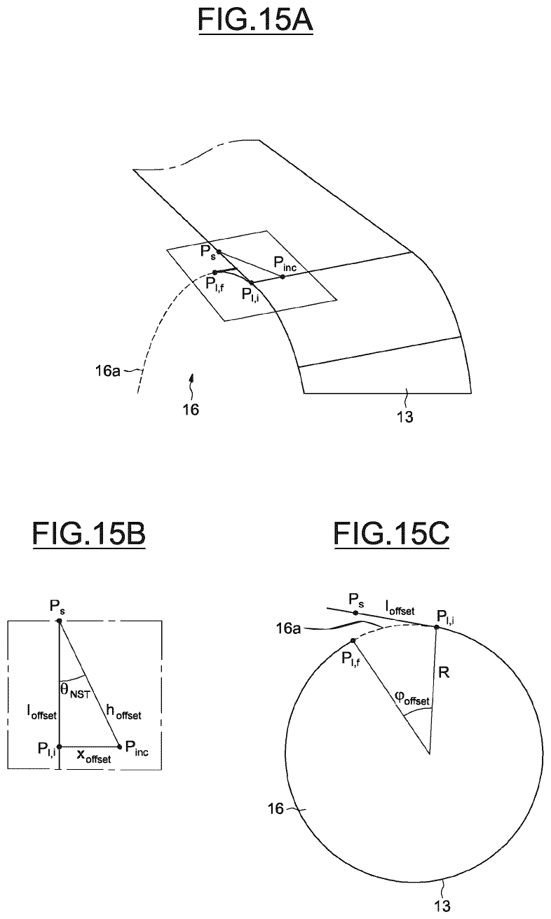

FIG. 15A, schematically shows the initial point of interest P_{1,i}, and the final point of interest P_{F,i};

FIG. 15B is a detail of FIG. 15A;

FIG. 15C shows the rotation angle φ for the support of the elastomeric element;

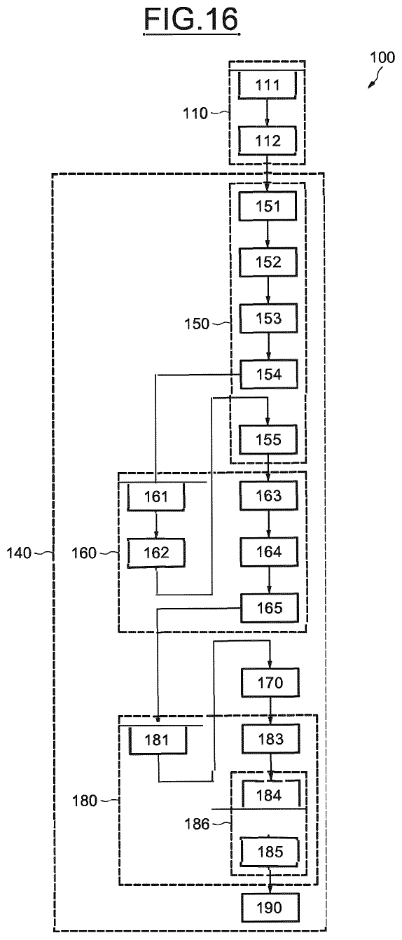

FIG. 16 is a flowchart depicting some steps of the method for manufacturing green tyres according to the invention.

In the remainder of the description, a first orthonormal reference frame or base X, Y, Z is considered, associated with the facility 10 for manufacturing green tyres, and comprising:
a longitudinal axis X, horizontal and extending from rear to front in FIG. 1, and parallel to the axis of rotation X-X′ of the drum 16;
a transverse axis Y, horizontal, perpendicular to the longitudinal axis X and extending from left to right in FIG. 1; and
a vertical axis Z, orthogonal to the longitudinal X and transverse Y axes and extending from bottom to top in FIG. 1.

A second orthonormal reference frame or base X, Y, Z is also considered, associated with the tool, specifically with the gripper 25 used, and comprising:
a longitudinal axis X1, horizontal and extending from left to right in FIG. 7;
an axis of extension Y1, horizontal, perpendicular to the longitudinal axis X1 of the gripper reference frame and extending from bottom to top in FIG. 7; and
a vertical axis Z1, orthogonal to the longitudinal axis X and axis of extension Y1 and extending from rear to front in FIG. 7, said vertical axis Z1 coinciding with the vertical axis Z of the reference frame associated with the facility.

FIG. 1 depicts a facility 10 for manufacturing green tyres comprising a feed station 12 for feeding elastomeric elements 13 and at least one laying station 14 for laying said elements.

The term “elastomeric element” means an elastomeric product, optionally reinforced, calandered or extruded with a given profile in such a way as to form a continuous strip or ply and, by extension, a set of preassembled elastomeric elements. An elastomeric element 13 is in this case wound on a spool 15.

The laying station 14 comprises a green tyre manufacturing drum 16 (partially shown), a robotic arm 18 provided with an effector 20 or tool suitable for the step of manufacturing the green tyre, and a platform 21 for presenting the product.

The term “laying station” also means the zone in which the elastomeric elements are laid.

As shown, and without this being in any way limiting, the feed station 12 for feeding elastomeric elements 13 comprises a multi-axis industrial robot 34 adapted to manipulate a container holding an elastomeric element.

The term “feed station” also means the zone in which the industrial robot 34 is located. The feed station 12 is adjacent to the laying station 14 and comprises a storage space 36 in which the containers are placed.

For example, the containers are in the form of spools 15, pay-off reels 38 including a spool 15 or roller tables holding an elastomeric element unsuitable for being stored on a spool.

The manufacturing facility 10 comprises an electronic control unit 40, ECU, configured to operate the feed station 12 and the laying station 14.

The ECU 40 is adapted, in particular, to control the automatic laying of the elastomeric elements 13 on the drum 16.

The drum 16 has the shape of a generally straight cylinder with symmetry of revolution about a central axis X-X′. The drum 16 is rotatable about the central axis X-X′ with respect to a holder 24 which is fixed or movable in the horizontal plane by means, for example, of a carriage 23, or movable in several directions by means, for example, of a multi-axis industrial robot.

The radially outer surface 16a of the drum 16 constitutes a laying surface with which the one or more first laid elements 13 are in contact. The one or more second laid elements are in contact with the radially outer surface of the one or more first laid elements.

The robotic arm 18 may be of six-axis type, and comprises a series of six portions of variable lengths, articulated to one another by six joints or pivots, this in no way being limiting. By way of example, the robot comprises a base 18a pivotally mounted via a first joint (not visible) on a fixed structure or gantry 28, a first segment or shoulder 18b pivotally movable via a second joint 26 with respect to the base 18a, a second segment or elbow 18c pivotally movable via a third joint 26a with respect to the first segment 18b and a wrist 18d pivotally movable along three distinct axes of rotation with respect to the second segment 18c via three joints (not visible). The base 18a and the wrist 18d are rotatable on themselves. Each joint or pivot is actuated by an electric motor (not shown). The one or more grippers 20 are mounted as one with the wrist 18d. Depending on the tools used and the arrangement of the laying station 14, the robotic arm 18 may take various forms with more or fewer axes of mobility.

The robotic arm 18 is configured to carry out the automatic and successive laying of an elastomeric element 13 on the drum 16.

For the gripping and anchoring steps, a single robot arm is required.

As explained hereinafter, the end portion 13a of the elastomeric element has a triangular shape oriented in either direction.

Thus, the facility could comprise a second robotic arm identical and parallel to the first robotic arm. The presence of a second robotic arm makes it possible to grip the end of the end portion 13a of an elastomeric element 13 oriented in the second direction. The second robotic arm may also be used in the cutting step to hold the end portion against the drum.

In general, the facility could comprise one or two robotic arms 18.

The tools 20 for carrying out automatic laying are selected from the group comprising at least one gripper 25 and scissors. The gripper 25 will be described in detail below with reference to FIGS. 4 and 7.

The tools 20 may also comprise rollers for applying pressure to the element once laid on the outer surface 16a of the drum 16 and pressing it against said outer surface 16a.

As shown, the facility 10 comprises a robotic arm 18 protruding above the drum 16, preferably to more or less 0.5 m from the central axis X-X′ of the drum 16 in a horizontal direction.

As shown in detail in FIG. 2A, the platform 21 for presenting the product is arranged upstream of the drum 16 and upstream of a mechanical guide GM.

The platform 21 comprises a flat receiving surface 21a for receiving an end 13a of the elastomeric element 13, and in particular the end portion 13a of said element 13 after partial unwinding from the spool 15.

The mechanical reinforcement of an elastomeric element 13 coupled with the fact that said element is wound around the spool 15 give rise to a surface of the end portion 13a which is not completely flat after being unwound on the platform 21 with a view to being laid on the outer surface 16a of the drum 16, as can be seen in FIG. 2B.

The platform 21 may comprise, for this purpose, a plate or strip that is made of magnetic material or magnetized 21b, extending along the longitudinal axis X and arranged on the receiving surface 21a for receiving the elastomeric element 13. The magnet 21b makes it possible to attract the threads of the elastomeric element 13 having magnetic properties and thus to press the end portion 13 of said element 13 on the platform 21. Alternatively, provision could be made for the platform 21 not to comprise such a magnet 21b.

The stiffness of the elastomeric element 13 may influence the position of its end unwound on the flat surface 21a of the platform 21. In other words, the longitudinal position of the end portion 13a of the unwound elastomeric element 13 may extend along an axis of extension Y1 that may be angularly offset from the transverse axis Y perpendicular to the axis X-X′ of rotation of the drum 16.

FIG. 3A depicts the case in which the end portion 13a of the unwound elastomeric element 13 extends along an axis of extension Y1 that is not angularly offset from the transverse axis Y perpendicular to the axis of rotation X-X′ of the drum 16. This case is particularly rare.

FIG. 3B depicts the case in which the end portion 13a of the unwound elastomeric element 13 extends along an axis of extension Y1 that is angularly offset inward from the transverse axis Y, while FIG. 3C depicts the case in which the end portion 13a of the unwound elastomeric element 13 extends along an axis of extension Y1 that is angularly offset outward from the transverse axis Y.

The gripper 25, shown in detail in FIGS. 4 and 7, comprises three rows of magnetic elements or magnets 25a, 25b, 25c, 25e, 25f that are parallel to one another and to the axis of rotation of the drum 16. The rows of magnetic elements are spaced apart from one another regularly in the direction of extension Y1.

As shown, the first and second rows of magnetic elements each comprise one magnetic element 25a, 25b and the third row comprises three magnetic elements 25c, 25e, 25f. One of the magnetic elements 25c of the third row is aligned along the axis of extension Y1′ with the magnetic elements 25a, 25b of the first and second rows.

The set of magnetic elements 25a, 25b, 25c, 25e, 25f is in this case arranged to form a T. In general, the shape of the gripper is symmetrical.

By virtue of the T-shaped arrangement of the magnets or a symmetrical arrangement of the gripper, it is possible to use the same gripper to grip the end portion of an elastomeric element oriented to the right or the end portion of an elastomeric element oriented to the left.

Alternatively, provision could be made for the third row to comprise only one magnetic element.

As shown, the gripper 25 comprises five magnetic elements.

Alternatively, provision could be made for the gripper 25 to comprise a different number of magnetic elements, for example greater than or equal to six.

The magnetic elements 25a, 25b, 25c, 25e, 25f are mounted on a holder 25d configured to be connected to the end portion of one of the robotic arms 18.

The gripper 25 of the robotic arm 18 is configured to grip the end portion 13a of the elastomeric element 13 from above.

However, since the gripper 25 is rigid, it is not possible to align it with the end portion 13a of the elastomeric element 13 if the end portion extends along the axis of extension Y1 that is angularly offset from the transverse axis Y as shown FIG. 3B or FIG. 3C.

The facility 10 comprises a first three-dimensional camera (not shown), such as an RGB-D sensor, rendering a point cloud of coordinates measured in a reference frame associated with said first camera and having a line of sight oriented towards the platform 21 and configured to acquire an image of the end portion 13a of the elastomeric element 13 on the platform 21. This step corresponds to a step 151 of acquisition of the image of the elastomeric element 13 on the platform 21. The first 3D camera is attached to the gantry 28 and directed upstream towards the platform 21.

The first 3D camera makes it possible to avoid the recalibration which is necessary when a 2D camera is used. To be specific, the first 3D camera will immediately match up the distance of the object and its perceived size, thereby making it possible to measure the dimensions of the object without having to indicate the depth at which it is with respect to the camera.

The electronic control unit ECU 40 comprises for this purpose a gripping module 50 for gripping the end portion 13a of the elastomeric element 13.

The gripping module 50 comprises an acquisition module 51 for acquisition of the image of the end portion 13a of the elastomeric element 13 on the platform 21 by the first 3D camera.

The gripping module 50 further comprises a splitting module 52 for splitting the image of the end portion 13a of the elastomeric element 13 on the platform 21 into three zones Z1, Z2, Z3, visible in FIG. 3B.

The first zone Z1 corresponds to the zone between the tip Pₚₒ of the end portion 13a, visible in FIG. 3D, and the second zone Z2, the second zone Z2 is located between the first and third zones Z1, Z3 and the third zone Z3 is located between the second zone Z2 and the edge 21c of the platform 21. The total length L of the end portion 13a of the element 13 corresponds to the distance between the tip Pₚₒ of said end portion 13a and the edge 21c of the platform 21.

Preferably, the first and third zones Z1, Z3 each correspond to 30% of the total length L. Alternatively, the length of the first zone Z1 could be different to the length of the third zone Z3. For example, the length of the first zone Z1 could be between 20% and 30% of the total length L and the length of the third zone Z3 could be between 20% and 30% of the total length L.

The gripping module 50 further comprises a determination module 53 for determining the position of the gripper 25 and in particular of a gripping point Pₚ of the gripper 25.

The determination module 53 for determining the position of the gripper 25 is configured to determine a straight line d1 passing through the lateral side of the second zone Z2.

The gripping point Pₚ is axially offset from the tip Pₚₒ of the end portion 13a by a distance dₚ.

The determination module 53 for determining the position of the gripper 25 further comprises a first image processor configured to determine an initial position of the tip or initial gripping point Pₚᵢ in the point cloud of the image from the acquisition module 51.

The image processor comprises the following successive steps, shown with reference to FIG. 5, with a reference frame u, v specifically for the image. The processor detects, in the image, the region of the platform 21, and then binary thresholding is performed in that region. The binary thresholding may be performed using a method known as Otsu.

In the binary image obtained, the largest contour C is detected, from which extreme pixels are extracted, respectively to the left, right and bottom of the contour P_{max,g}, P_{max,d} and P_{max,b}.

These three pixels are then used to determine the orientation of the end portion 13a of the elastomeric element 13. A first distance between the extreme left pixel P_{max,g} and the extreme bottom pixel P_{max,b} is compared with a second distance between the extreme right pixel P_{max,d} and the extreme bottom pixel P_{max,b}, and if the first distance is greater than the second distance, i.e. if ∥P_{max,g}−P_{max,b}∥>∥P_{max,d}−P_{max,b}∥, then it is an elastomeric element oriented to the left, otherwise it is an elastomeric element oriented to the right.

Lastly, the pixels of the right lateral edge p_{d,i} of the end portion 13a and the pixels of the left lateral edge p_{g,i} are detected by searching for the intersection between N vertical lines and the contour C of the second zone Z2 of the end portion 13a of the elastomeric element 13.

The first camera, of RGB-D type, further makes it possible to obtain a depth frame superimposed with a colour image, to retrieve depths of points of interest obtained from the image processing performed on the colour image and then calculate the three-dimensional coordinate of each of said points to obtain the three-dimensional image as shown in FIG. 6. Thus, for each pixel of the image acquired, it is possible to retrieve its depth and then its coordinate in space.

The first image processor is configured to estimate the 3D point of the tip Pₚₒ obtained from the pixel P_{max,b}, along with the left and right lateral 3D points P_{g,i} and P_{d,i} obtained from the pixels p_{g,i} and p_{d,i}, respectively.

The first image processor is configured to estimate the straight lines d2, d3 passing through these points P_{g,i} and P_{d,i}, to calculate the angle θ_{NST} formed between these two straight lines d2, d3 and to obtain the initial gripping point Pₚᵢ by projecting the point Pₚₒ, itself projected in the plane defined by the two straight lines d2, d3.

The projection distance between these points corresponds to the distance dₚ mentioned above.

The first image processor is then configured to translate the initial gripping point Pₚᵢ by a distance Ra along the longitudinal axis X1 and the axis of extension Y1 of the second reference frame X1, Y1, Z1 associated with the gripper 25, i.e. to the left and to the rear in the case of an elastomeric element 13 oriented to the right, or to the right and to the rear in the case of an elastomeric element 13 oriented to the left.

FIG. 7 shows the translation of the initial gripping point Pₚᵢ by the distance Ra to the left and to the rear in the case of an elastomeric element 13 oriented to the right to obtain the gripping point P_{pf} transmitted to the robotic arm 18 by a transmission module 54.

The distance Ra corresponds to the radius of the magnets 25a, 25b, 25c of the gripper 25.

Such translation by the distance Ra along the longitudinal axis X1 of the second reference frame X1, Y1, Z1 makes it possible to increase the surface area of the gripper 25 for magnetization with the end portion 13a of the elastomeric element 13.

To be specific, the gripper 25 is initially aligned with the straight line d1, there is a shift by the distance −Ra along the longitudinal axis X1 of the second reference frame when gripping the end portion 13a of the elastomeric element 13, and a shift by the distance +Ra along the longitudinal axis X1 when laying so as to cancel out this shift.

A similar procedure is followed along the axis of extension Y1 of the second reference frame X1, Y1, Z1.

The electronic control unit ECU 40 further comprises an anchoring module 60 for anchoring said end 13a on the outer surface 16a of the drum 16.

Once the end portion 13a of the elastomeric element 13 has been gripped by the gripper 25, it is necessary to move it to the drum 16 and anchor it on the outer surface 16a of said drum 16.

To this end, the surface of the end portion 13a is rolled onto the outer surface 16a of the drum 16 by applying a contact pressure and gradually releasing the anchored portions of the end portion 13a.

Since the gripper 25 is rigid, the end portion 13a cannot be anchored on the drum 16 in a single laying operation. As the gripper 25 comprises three rows of magnets 25a, 25b, 25c, 25e, 25f, the anchoring step is performed in three successive laying operations R_{T1}, R_{T2} and R_{T3}, i.e. one laying operation per row of magnets 25a, 25b, 25c, 25e, 25f.

To determine these laying instructions R_{T1}, R_{T2} and R_{T3}, the anchoring module 60 comprises a laser projection module 61 for projecting lasers, namely a first fixed red vertical laser L1 indicating the centre of the drum 16, a second fixed green horizontal laser L2 indicating the azimuth of laying of the elastomeric elements and two variable green vertical lateral lasers L3, L4 indicating the longitude of laying, on the outer surface 16a of the drum 16.

Lasers L3, L4 having a wavelength corresponding to the colour green are preferred because the colour green can be differentiated more easily from the rubber of the tyre. Indeed, the rubber tends to reflect red, which attenuates the contrast of the lasers. Alternatively, provision could be made for the lasers L3, L4 to have a wavelength corresponding to the colour red or another colour.

Similarly, the lasers L1 and L2 could have a wavelength corresponding to a colour other than red, for example green or another colour.

The lasers are attached to the gantry 28.

The facility 10 further comprises a second three-dimensional camera (not shown) rendering a point cloud of coordinates measured in a reference frame associated with said second camera and having a line of sight oriented towards the drum 16 and configured to acquire an image of a laying zone on the outer surface 16a of the drum 16.

The second camera is, for example, an RGB-D sensor.

The second camera is set to highlight the various lasers L1, L2, L3, L4. By way of non-limiting example, the second camera may be set to increase exposure so as to capture light from the lasers, to increase saturation so as to highlight the dominant colours and to modify the white balance so as to highlight the colour green.

The anchoring module 60 comprises an acquisition module 62 for acquisition of an image of the outer surface 16a of the drum 16, in particular the laying zone, by the second camera attached to the gantry 28 and directed towards the drum 16. The image acquired of the outer surface 16a of the drum 16 is visible in FIG. 8.

The acquisition of the image of the laying zone on the outer surface 16a of the drum 16 is carried out before the end portion 13a of the elastomeric element 13 is gripped by the gripper 25 in order to anticipate the trajectory of the robotic arm 18 and know where to anchor said end 13a.

Carrying out this acquisition step upstream of the gripping of the end portion 13a of the elastomeric element 13 makes it possible to avoid creep of said end 13a.

The anchoring module 60 further comprises an image processing module 63 for processing the image of the laying zone comprising a second image processor configured to detect the lasers L1, L2, L3, L4 and a 3D point cloud.

Said image processing module 63 is further configured to isolate the pixels associated with the lasers in the image acquired using colour segmentation in the image, converted to a saturated image, referred to as Hue, Saturation, Value or HSV.

Said module 63 is configured to detect an intersection pixel pᵢ at the intersection between the second horizontal laser L2 and one of the lateral lasers L3, L4, namely the right lateral laser L3 if the end portion 13a of the elastomeric element 13 is oriented to the right, or the left lateral laser L4 if the end portion 13a is oriented to the left.

The axis X-X′ of the drum 16 is defined by the vector between the intersection pixel pᵢ and a middle pixel of the drum pₘ detected at the intersection between the first vertical laser L1 and the second horizontal laser L2.

Using the depth information of the camera, it is possible to estimate an intersection point P₁ and a middle point Pₘ corresponding to the three-dimensional points of the intersection pixel pᵢ and the middle pixel of the drum pₘ.

The anchoring module 60 comprises a module 64 configured to determine the anchoring point P₁, P₂, P₃ of each of the magnets 25a, 25b, 25c with respect to the intersection point P₁ in a plane Pi (π) of normal \vec{n}_{π}, where a circle C fit on the point cloud of one of the lateral lasers L3, L4 in FIG. 8 is located and as a function of a distance dᵣ between two rows of magnets 25a, 25b, 25c, 25e, 25f and the radius Rₐ of a magnet 25a, 25b, 25c, 25e, 25f.

FIG. 9 shows how the anchoring points P₁, P₂, P₃ of each of the rows of magnets 25a, 25b, 25c, 25e, 25f are positioned with respect to the intersection point P₁ in a plane Pi (π) of normal \vec{n}_{π};

To determine the position of the first anchoring point of the first row of magnet 25a on the fit circle C, the intersection point PI is pivoted about the axis of the circle by an angle θ_{I1} according to the following equation:

θ_{I1}=Rₐ/R [Eq. 1]

Where R is the measured radius of the drum 16.

Respectively, the position of the second and third anchoring points P2, P3 of the second and third rows of magnets 25b, 25c on the fit circle C are defined as follows by pivoting the intersection point P₁ about the axis of the circle respectively by an angle θ_{I2} and θ_{I3} according to the following equations:

θ_{I2}=(Rₐ+dᵣ)/R [Eq. 2]

θ_{I3}=(Rₐ+2dᵣ)/R), [Eq. 3]

The fit circle C of centre P_{c} and radius R is determined as a function of the axis of the drum, the radius of the drum, and the centre of the circle

The axis of the drum is determined by means of the vector \vec{P_{I}Pₘ}, and the radius may be obtained in two ways: by measuring with a telemeter or estimating the diameter.

To determine the circle of centre P_{c}, said module 64 is configured to fit a circle on the 3D point cloud of one of the lateral lasers L3, L4. The equation sought is is derived from that of a large circle C in [symbol] ³, in other words a circle drawn on a sphere having the same centre as the sphere. In other words, the axis of the drum is the normal of the intersection between a sphere of the same radius as the drum 16 and a plane passing through the centre of this sphere.

With Pᵢ as any point on the sphere, the first relation is obtained:

(xᵢ−x_{c})²+(yᵢ−y_{c})²+(zᵢ−z_{c})²−R²=0 [Eq.4]

With the plane π of normal \vec{n}_{π} in which the large circle is located, the following relation is obtained for any point Pᵢ:

\vec{n}_{π}·\vec{P_{c}Pᵢ}=0 [Eq.5]

Developing this, the following equation is obtained:

n_{π,x}(x_{c}−xᵢ)+n_{π,y}(y_{c}−yᵢ)+n_{π,z}(z_{c}−zᵢ)=0 [Eq.6]

By setting the radius R and the normal \vec{n}_{π}, the point P_{c} is ultimately sought such that, for any point of intersection P₁, the following equation is solved numerically:

((xᵢ−x_{c})²+(yᵢ−y_{c})²+(zᵢ−z_{c})²−R²)²+(n_{π,x}(x_{c}−xᵢ)+n_{π,y}(y_{c}−yᵢ)+n_{π,z}(z_{c}−zᵢ))₂=0 [Eq.7]

Once the circle C has been defined, it is necessary to work in a two-dimensional space to perform the various rotations about said circle.

FIG. 10A depicts the circle C fit on the point cloud of the laser. The projection of the intersection point P₁ on the fit circle C, P_{I/C}, is rotated about the centre of the circle to find the anchoring points P₁, P₂, P₃ of each of the magnets 25a, 25b, 25c. This projection is necessary to ensure that all points are on the fit circle C. The vectors \vec{x}ᵢ, \vec{y}ᵢ and \vec{z}ᵢ of the anchoring points P₁, P₂, P₃ are determined using the following relations:

\vec{x}ᵢ=\vec{n}_{π}; and \vec{z}ᵢ=\vec{PᵢP_{c}}

Thus, the vector ŷᵢ is defined as the vector product of these vectors, i.e. \vec{y}ᵢ=\vec{z}ᵢ∧\vec{x}ᵢ.

The second anchoring point P_{2, TCP} of the second row of magnet 25b is determined by translating the second intersection point P₂ by a distance dᵣ along the axis \vec{y}₂, as shown in FIG. 10B.

Likewise, the third anchoring point P_{3, TCP} of the third row of magnets 25c, 25e, 25f is determined by translating the third intersection point P₂ by a distance 2dᵣ along the axis \vec{y}₃.

The gripper 25 therefore follows the trajectory of the reference frames [symbol] _{3,TCP}, [symbol] _{2,TCP}, then [symbol] _{1,TCP} in that order to anchor the end portion 13a of the elastomeric element 13 to the third point P₃, then to the second point P₂ and lastly to the first point P₁.

FIG. 10B shows the shifts for obtaining the reference frames [symbol] _{2,TCP} and [symbol] _{3,TCP}.

To go from the reference frames [symbol] _{3,TCP} to [symbol] _{2,TCP} then from [symbol] _{2,TCP} to [symbol] _{1,TCP}, the robotic arm 18 should ideally follow a trajectory which is an involute of a circle to roll the surface of the end portion 13a of the elastomeric element 13 onto the surface 16a of the drum 16 by applying a contact pressure. However, given the flexibility of the end portion 13a of the elastomeric element 13 and the short distances between the various anchoring points, it may be assumed that an approximation of such involutes is sufficient. In short, the robotic arm 18 follows a linear trajectory between each anchoring point and only the three anchoring points computed are transmitted to said arm 18.

The module 64 for determining the anchoring points is configured to take into account the shifts dₚ and Rₐ previously determined when gripping the end portion 13a of the elastomeric element 13.

The three anchoring points P_{1, TCP}, P_{2, TCP}, P_{3, TCP} are thus shifted by the radius −Rₐ along the longitudinal axis X to compensate for the translation of the entire gripper 25 and the first anchoring point P_{1, TCP} is shifted by the distance dₚ along the longitudinal axis X to compensate for the shift relative to the tip of the end portion 13a and ultimately obtain the anchoring points P₁, P₂, P₃ of each of the magnets 25a, 25b, 25c.

The anchoring points P₁, P₂, P₃ of each of the rows of magnets 25a, 25b, 25c, 25e, 25f are then transmitted to a control module 65 for controlling the gripper 25.

The gripper control module 65 is configured to separately control the magnets 25a, 25b, 25c of the gripper 25 and in particular the actuators (not shown) of each magnet.

To be specific, when the end portion 13a of the elastomeric element 13 is being anchored on the drum 16, the actuators must be deactivated row by row to release the anchored zones of the elastomeric element 13.

FIG. 11 depicts an example of a pneumatic diagram of control of the actuators of the rows of magnets 25a, 25b, 25c, 25e, 25f of the gripper 25. The second and third actuators are each connected to a secondary pneumatic directional valve 26a, 26b, for example of 5/2 type, connected to a main pneumatic directional valve 26c, for example of 5/3 type. The first actuator of the first magnet 26a is connected directly to the main pneumatic directional valve 26c.

The anchoring module 60 makes it possible to anchor a product of complex shape on a rounded shape, i.e. the drum, by determining three anchoring points belonging to the same circle.

The ECU 40 further comprises a support module 70 configured to wind the elastomeric element 13 around the drum 16 over a 360° revolution once the end portion 13a of said element 13 has been anchored on the outer surface 16a of the drum 16, as shown in FIGS. 12A and 12B.

The ECU also comprises a cutting module 80 configured to cut said elastomeric element 13 wound around the drum 16 to the desired length.

The elastomeric elements 13 reinforced with metal fibres must be cut between and along two metal fibres.

The cutting module 80 is configured to transmit instructions to one of the robotic arms 18 to insert the cutting tool between two metal threads at an incision point P_{inc}, to cut up to an exit point P_{S}, to return to the incision point P_{inc}, and then to cut the rest of the elastomeric element 13 up to an end point P_{F} as shown in FIGS. 13A, 13B, 13C and 13D.

The remainder of the elastomeric element 13 is cut up to a final point P_{F} by synchronizing the robotic arm 18 with the rotation of the drum 16.

The cutting module 80 comprises a cutting preparation module 81 configured to determine the incision point P_{inc}.

The incision point P_{inc} is determined upstream of the support operation.

When the elastomeric element 13 is cut and its surface rolled onto the surface of the drum 16, the exit point P_{S} of the cut coincides with an initial point of interest P_{I,i} as shown in FIG. 14A. This point of interest is at the other end of the hypotenuse of the right-angled triangle formed by the tip of the end portion 13a of the elastomeric element 13.

At the end of anchoring of the end portion 13a of the elastomeric element 13 on the drum 16, the elastomeric element 13 is in the position shown in FIG. 14B.

The cutting preparation module 81 is configured to place the incision point in a region of interest ROI defined manually. This region of interest ROI is chosen between the mechanical guide GM downstream of the platform 21 and the top of the drum 16 so that the cutting tool has sufficient space to incise the elastomeric element 13.

In FIG. 14C, the region of interest ROI is located at the known azimuth A1, itself located at an angle β from the azimuth A2 of the horizontal laser L2 where the elastomeric element 13 was anchored in the anchoring step. The target distance between the initial point of interest P_{I,i} and the guide boundary is denoted Δ_{g}.

With I_{NST} the width of the elastomeric element 13, L the length of the side adjacent to the angle θ_{NST} and R the radius of the drum 16, to place the initial point of interest P_{L,i} at the azimuth A2 of the laser L2, it is necessary to rotate the drum by an angle γ_{L}=L/R.

To place the initial point of interest P_{I,i} in the region of interest ROI, it is therefore necessary to rotate the drum 16 by an angle γ=L/R−β.

To detect the initial point of interest P_{I,i} in the location zone, grazing incident lighting is used to make it possible to distinguish the elastomeric element 13 from the lower layer on the drum 16. This creates a shadow along the edge of the elastomeric element 13 which defines a contour in the image.

The cutting preparation module 81 comprises an image processor 82 configured to determine the initial point of interest P_{I,i}.

The inputs of the algorithm are the 3D image from the second camera directed towards the drum 16, the depth frame, and a mask in which the white pixels represent the region of interest ROI where the initial point of interest P_{I,i} has been placed.

To detect the contours, the image processor 82 uses a Sobel filter (not shown) configured to detect by convolution horizontal and then vertical intensity variations. By combining the results, a gradient at each point is obtained.

In the case at hand, only diagonal contours are sought, and therefore the image processor 82 applies both times the Sobel filter with a 3×3 diagonal convolution matrix.

For an elastomeric element 13 oriented to the left, this matrix is written as follows:

$${M}_{SG} = [ \begin{matrix}0 & 1 & 2 \\ - 1 & 0 & 1 \\ - 2 & - 1 & 0\end{matrix} ]$$

For an elastomeric element 13 oriented to the right, this matrix is written as follows:

$${M}_{SD} = [ \begin{matrix}- 2 & - 1 & 0 \\ - 1 & 0 & 1 \\ 0 & 1 & 2\end{matrix} ]$$

The use of a diagonal matrix is optimal for the elastomeric elements the end portion 13a of which forms an angle of 45° with the transverse axis Y. Another angle of the end portion 13a could be provided.

Then, the image processor 82 is configured to use a binary thresholding method to obtain a black and white image of the results and configured to focus in the region of interest ROI to detect the largest contour of the image so as to isolate it in a black and white image.

For each line of the image that contains at least one white pixel, only the pixel furthest to the right (for an elastomeric element 13 oriented to the left) is retained in order to refine the contour as close as possible to the elastomeric element 13. The contour is then expanded to the right only using an expansion function with a convolution vector k=[1, 1, 1, 1, 1, 1, 0, 0, 0, 0, 0].

The image processor 82 is then configured to perform a new contour search and search for the convex envelope of this contour to obtain a polygon with vertices represented by pixels.

This step makes it possible to reduce the number of pixels of the contour to work only with the vertices of the convex envelope. Thus, a pixel pᵢ is determined to be the lowest vertex out of the two vertices furthest to the left.

During the cutting movement, the cutting tool must not strike either the mechanical guide or the drum 16. This is why it is necessary for the point of interest P₁ to be at a distance Δ_{g±ϵ} from the mechanical guide GM.

To measure this distance Δ_{g±ϵ}, the image processor 82 uses a pixel p_{dir} which is the highest vertex out of the two vertices furthest to the left.

The straight line d_{NST} is the straight line in the 2D image defined by two pixels p_{I} and p_{g}. The pixel p_{g} corresponds to the intersection between the straight line d_{NST} and a straight line d_{g} in the image defined manually and representing the boundary of the mechanical guide.

The distance between the points P_{I,i} and P_{g}, obtained from the pixels p_{I} and p_{g}, is compared with the distance Δg. If the initial point of interest P_{I,i} is too close to the mechanical guide GM, then the effector 20 risks being impeded thereby, and if the initial point of interest P_{I,i} is too far away, the effector 20 risks being impeded by the drum 16.

The image processor 82 shifts the elastomeric element 13 so that the initial point of interest P_{I,i} obtained from the pixel pᵢ is at a distance Δg, ideal for the incision motion. This shift is performed by a rotation of the drum 16 the direction of rotation of which depends on the sign of the shift to be performed.

For example, Δg=0.055 m and □=0.01.

After having detected the initial point of interest P_{I,i} and after having verified the distance Δg between this point and the mechanical guide GM, the elastomeric element 13 is supported by the support module 70 before the cutting operation is performed, i.e. winding the elastomeric element 13 around the drum 16. This operation is performed by synchronizing the rotation of the drum 16 with the rotation of the spool 15.

Once the elastomeric element 13 is supported, the initial point of interest P_{I,i}, determined before the support operation, and the final point of interest P_{F,i} which is the physical point of interest forming part of the elastomeric element 13 and which has therefore rotated around the drum 16 therewith, are distinguished in FIG. 15A.

The cutting module 80 comprises a module 83 for determining the incision point P_{inc} as a function of the initial point of interest P_{I,i} and a constant distance h_{offset} between and said incision point P_{inc} and the exit point P_{S} required for the cutting phases shown in FIGS. 13A, 13B, 13C.

The constant distance h_{offset} is predetermined in prior steps that will not be described.

The incision point P_{inc} is axially offset x_{offset}=sin θ_{NST}·h_{offset} from the initial point of interest P_{I,i} along the axis X-X′ of the drum 16 as in FIG. 15B.

The length l_{offset} between the exit point P_{S} and the initial point of interest P_{I,i} is written as follows:

l_{offset}=h_{offset}·cos θ_{NST}

As shown in FIG. 15C, the rotation angle φ for the support of the elastomeric element 13 is therefore not 2π but is equal to 2π−φ_{offset} where φ_{offset}=l_{offset}/R.

Thus, the exit point P_{S} coincides with the final point of interest P_{F,i} once the elastomeric element 13 is adhered to the drum 16.

The cutting module 80 further comprises a heating module 84 for heating the cutting tool (not shown).

The cutting module 80 further comprises a module 85 for analysing the axial forces Fₓ and transverse forces F_{y} of the robotic arm 18 generated during the cutting operation, configured to acquire said force by a force sensor mounted on the robotic arm 18, to determine the cutting exit point P_{S} and to correct in real time the angle of the cutting tool during the cutting operation.

Lastly, the ECU 40 comprises a welding module 90 configured to press the elastomeric element 13 as close as possible to the cut and to control a multi-profile press roll capable of rolling in all directions and accompanying the elastomeric element 13 as cutting proceeds.

The welding module 90 is also configured to control a welding tool, referred to as a zipper, configured to bring the cut ends of the elastomeric element 13 together in a first direction and a second direction along the weld.

The flowchart in FIG. 16 depicts some manufacturing steps of a method 100 for manufacturing green tyres.

The method 100 comprises a step 140 of successively laying elastomeric elements 13 using the manufacturing facility 10.

To this end, the method 100 comprises, prior to the laying step 140, a step of feeding 110 the laying station 14 with an elastomeric element 13, with the aid of the feed station 12, the element to be laid taking the form of a continuous strip or ply.

The feed step 110 comprises a step 111 of gripping a container, such as a spool 15, a pay-off reel 38 including a spool 15, or a roller table, by a multi-axis industrial robot 34 or an autonomous carriage. Each container comprises an elastomeric element to be laid. The feed step 110 further comprises a step 112 of positioning the container such that the elastomeric element is ready to be laid and unwinding the elastomeric element 13 until its end 13a is laid on the surface 21a of a platform 21 of the facility 10.

The laying step 140 is automatically controlled by the ECU 40. One of the robotic arms 18, provided with the gripper 25, automatically lays the elastomeric element 13 on the green tyre manufacturing drum 16 according to the following sequence.

The laying step 140 comprises a sequence including a step 150 of gripping the end portion 13a of the elastomeric element 13, a step 160 of anchoring said end 13a on the outer surface 16a of the drum, a step 170 of supporting the elastomeric element 13 around the drum, a step 180 of cutting the elastomeric element 13 to the desired length, and a step 190 of welding the cut portion of the elastomeric element with the anchored end portion 13a.

The step 150 of gripping the end portion 13a of the elastomeric element 13 comprises a step 151 of acquisition of the image of the end portion 13a of the elastomeric element 13 on the platform 21 by the first RGB-D camera.

The gripping step 150 further comprises a step 152 of splitting the image of the end portion 13a of the elastomeric element 13 on the platform 21 into three zones Z1, Z2, Z3, as described above with reference to the splitting module 52 for splitting the image of the end portion 13a.

The gripping step 150 comprises a step 153 of determining the position of the gripper 25 and in particular of a gripping point Pₚ with the aid of an image processor as described above with reference to the determination module 53 for determining the position of the gripper 25.

The gripping step 150 comprises a step 154 of correcting the initial gripping point Pₚᵢ by translating said initial gripping point Pₚᵢ by a distance Ra along the longitudinal axis X1 and the axis of extension Y1 of the reference frame of the gripper 25 to obtain the gripping point P_{pf} with the aid of the image processor as described above with reference to the determination module 53 for determining the position of the gripper 25.

The gripping point P_{pf} is then transmitted, in a transmission step 155, to the robotic arm 18.

In the step 160 of anchoring said end 13a on the outer surface 16a of the drum 16, a contact pressure is applied and the anchored portions of the end portion 13a are gradually released.

The anchoring step 160 comprises a step 161 of projecting lasers and a step 162 of acquisition of an image of the outer surface 16a of the drum 16 by a second RGB-D camera directed towards the drum 16.

The steps 161 and 162 are carried out before the step 155 of gripping of the end portion 13a of the elastomeric element 13 by the gripper 25 in order to anticipate the trajectory of the robotic arm 18 and know where to anchor said end 13a.

The lasers comprise a first fixed vertical laser L1, for example red, indicating the centre of the drum 16, a second fixed horizontal laser L2, for example green, indicating the azimuth of laying of the elastomeric elements and two variable vertical lateral lasers L3, L4, for example green, indicating the longitude of laying.

The anchoring step 160 further comprises a step 163 of processing the image of the laying zone in which the lasers L1, L2, L3, L4 and a 3D point cloud are detected, the pixels associated with the lasers are isolated in the image acquired, and the intersection pixel pᵢ is detected at the intersection between the second horizontal laser L2 and one of the lateral lasers L3, L4, namely the right lateral laser L3 if the end portion 13a of the elastomeric element 13 is oriented to the right or the left lateral laser L4 if the end portion 13a is oriented to the left. Step 163 of processing the image is performed using the image processing module 63 described above.

The anchoring step 160 further comprises a step 164 of determining the anchoring point P₁, P₂, P₃ of each of the rows of magnets 25a, 25b, 25c, 25e, 25f with respect to the intersection point P₁ in a plane Pi (π) of normal \vec{n}_{π} where a circle C fit on the point cloud of one of the lateral lasers L3, L4 is located and as a function of a distance dᵣ between two rows of magnets 25a, 25b, 25c and the radius Rₐ of a magnet 25a, 25b, 25c.

The anchoring point P₁, P₂, P₃ of each of the rows of magnets 25a, 25b, 25c, 25e, 25f is determined with reference to the anchoring point determination module 64 as described above.

The anchoring step 160 further comprises a step 165 of transmitting the anchoring points P₁, P₂, P₃ of each of the rows of magnets 25a, 25b, 25c, 25e, 25f to a control module 65 for controlling the gripper 25 configured to separately control the rows of magnets 25a, 25b, 25c, 25e, 25f of the gripper 25 and in particular the actuators of each row of magnets.

In step 170 of supporting the elastomeric element 13 around the drum, the elastomeric element 13 is wound around the drum 16 over a 360° revolution once the end portion 13a of said element 13 has been anchored on the outer surface 16a of the drum 16.

Step 180 of cutting the elastomeric element 13 to the desired length comprises a step 181 of preparing for cutting in which an incision point P_{inc} corresponding to the point of insertion of the cutting tool between two metal threads is determined, with the aid of the module 81 for preparing for cutting as described above.

Step 181 of preparing for cutting is carried out upstream of the support step 170.

In step 181 of preparing for cutting, a region of interest ROI and an initial point of interest P_{I,i} are determined as described above with reference to the module 81 for preparing for cutting and the image processor 82.

The cutting step 180 further comprises a step 183 of determining the incision point P_{inc} as a function of the initial point of interest P_{I,i} and a constant distance h_{offset} between and said incision point P_{inc} and the exit point P_{S} required for the cutting phases shown in FIGS. 13A, 13B, 13C, as described above with reference to the module 83 for determining the incision point P_{inc}.

The cutting step 180 further comprises a step 184 of heating the cutting tool during the cutting operation 186 and a step 185 of analysing the axial forces Fₓ and transverse forces F_{y} of the robotic arm 18 generated during the cutting operation 186, configured to acquire said force by a force sensor mounted on the robotic arm 18, to determine the cutting exit point P_{S} and to correct in real time the angle of the cutting tool during the cutting operation 186.

The step 190 of welding the cut portion of the elastomeric element with the anchored end portion 13a involves pressing the elastomeric element 13 as close as possible to the cut and controlling a multi-profile press roll capable of rolling in all directions and accompanying the elastomeric element 13 as cutting 186 proceeds.

In the welding step 190, a welding tool, referred to as a zipper, configured to bring the cut ends of the elastomeric element 13 together in a first direction and a second direction along the weld, is controlled.

The laying system and method according to the invention are designed to adapt to both existing manual facilities and new facilities.

1.-18. (canceled)

19. A facility for manufacturing green tires associated with a first orthogonal reference frame X, Y, Z and comprising:
a drum for manufacturing green tires that is rotatable about an axis of rotation X-X′ of the first reference frame;
a platform arranged upstream of the drum, extending along a transverse axis Y of the first reference frame and comprising a flat receiving surface for receiving an end of an elastomeric element;
at least one robotic arm;
an electronic control unit configured to operate the robotic arm; and
at least a first three-dimensional camera rendering a point cloud of coordinates measured in a reference frame associated with the first three-dimensional camera and having a line of sight oriented toward the platform and configured to acquire an image of the end portion of the elastomeric element on the platform,
wherein the robotic arm comprises at least one gripper associated with a second orthogonal reference frame X1, Y1, Z1 distinct from the first orthogonal reference frame X, Y, Z and configured to grip the end portion of the elastomeric element from above and comprising at least three rows of magnetic elements that are parallel to one another and spaced apart from one another regularly along an axis of extension Y1 of the second orthogonal reference frame X1, Y1, Z1, and
wherein the electronic control unit comprises at least:
a gripping module for gripping the end portion of the elastomeric element, configured to determine a gripping point Pp of the gripper on a basis of the point cloud rendered by the first three-dimensional camera, and
an anchoring module for anchoring the end portion on an outer surface of the drum, configured to determine an anchoring point P1, P2, P3 of each of the rows of magnetic elements on the outer surface of the drum.

20. The facility according to claim 19, wherein the end portion extends along the axis of extension Y1 of the second orthogonal reference frame angularly offset from the transverse axis Y of the first orthogonal reference frame X, Y, Z.

21. The facility according to claim 19, wherein the gripping module comprises:
an acquisition module for acquisition of the image of the end portion of the elastomeric element on the platform by the first three-dimensional camera;
a splitting module for splitting the image of the end portion of the elastomeric element on the platform into three zones Z1, Z2, Z3; and
a determination module for determining the gripping point Pp, comprising a first image processor configured to determine an initial gripping point Ppi in the point cloud of the image from the acquisition module and to correct the initial gripping point Ppi by translating the initial gripping point Ppi by a distance Ra corresponding to a radius of the magnetic elements of the gripper along the axis of extension Y1 of the second orthogonal reference frame X1, Y1, Z1 and along a second longitudinal axis X1 of the second orthogonal reference frame perpendicular to the axis of extension Y1 and to determine the gripping point Ppf transmitted to the robotic arm by a transmission module.

22. The facility according to claim 19, further comprising a first fixed vertical laser indicating the center of the drum, a second fixed horizontal laser indicating an azimuth of laying of the elastomeric element and two variable vertical lateral lasers indicating a longitude of laying, the lasers being rigidly secured to a fixed structure of the facility, and
wherein the anchoring module comprises a module for projecting the lasers onto an outer surface of the drum.

23. The facility according to claim 22, further comprising a second three-dimensional camera rendering a point cloud of coordinates measured in a reference frame associated with the second three-dimensional camera and having a line of sight oriented toward the drum and configured to acquire an image of a laying zone on the outer surface of the drum, and
wherein the anchoring module comprises:
an acquisition module for acquisition of an image of the laying zone, and
a module for processing the image of the laying zone, comprising a second image processor configured to detect the lasers and an intersection pixel pI at an intersection between the second horizontal laser and one of the lateral lasers and to estimate an intersection point PI and a middle point Pm corresponding to the three-dimensional points of the intersection pixel pI and the middle pixel pm of the drum.

24. The facility according to claim 19, wherein the electronic control unit further comprises a support module for supporting the elastomeric element around the drum, a cutting module for cutting the elastomeric element to a desired length, and a welding module for welding a cut portion of the elastomeric element with the end portion anchored on an outer surface of the drum.

25. The facility according to claim 19, wherein the gripper of the robotic arm comprises actuators each connected to a magnetic element, the actuators being separately controlled to successively release the third row of magnetic elements, the second row of magnetic element and then the first row of magnetic element.

26. The facility according to claim 19, wherein the magnetic elements of the gripper of the robotic arm are mounted on a holder configured to be connected to the end portion of the robotic arm.

27. The facility according to claim 19, wherein the first, second and third rows of magnetic elements of the gripper of the robotic arm each comprise at least one magnetic element.

28. The facility according to claim 26, wherein the first and second rows of magnetic elements of the gripper of the robotic arm each comprise a single magnetic element, and
wherein the third row comprises at least three magnetic elements, one of the magnetic elements of the third row being aligned along the axis of extension Y1 of the second orthogonal reference frame with the magnetic elements of the first and second rows.

29. The facility according to claim 19, further comprising a second robotic arm.

30. The facility according to claim 19, wherein the platform comprises at least one magnetized strip, extending along a longitudinal axis X parallel to the axis of rotation X-X′ of the drum and arranged on the receiving surface of the platform.

31. A method for automatic and successive laying of elastomeric elements by means of a facility for manufacturing green tires associated with a first reference frame X, Y, Z and comprising a drum for manufacturing green tires that is rotatable about an axis of rotation X-X′, a platform arranged upstream of the drum, extending along a transverse axis Y of the first orthogonal reference frame X, Y, Z and comprising a flat receiving surface for receiving an end of an elastomeric element, at least one robotic arm, and at least a first three-dimensional camera rendering a point cloud of coordinates measured in a reference frame associated with the first three-dimensional camera and having a line of sight oriented toward the platform and configured to acquire an image of the end portion of the elastomeric element on the platform, the robotic arm comprising at least one gripper associated with a second orthogonal reference frame X1, Y1, Z1 distinct from the first orthogonal reference frame X, Y, Z and configured to grip the end portion of the elastomeric element from above, and comprising at least three rows of magnetic elements that are parallel to one another and spaced apart from one another regularly along an axis of extension Y1 of the second orthogonal reference frame X1, Y1, Z1, the method comprising at least:
a laying step comprising a sequence comprising at least a step of gripping the end portion of the elastomeric element, during which a gripping point Pp of the gripper is determined on a basis of the point cloud rendered by the first three-dimensional camera; and
a step of anchoring the end portion on an outer surface of the drum, during which an anchoring point P1, P2, P3 of each of the rows of magnetic elements on the outer surface of the drum is determined.

32. The method according to claim 31, wherein the end portion extends along an axis of extension Y1 of the second orthogonal reference frame X1, Y1, Z1 angularly offset from the transverse axis Y of the first orthogonal reference frame X, Y, Z, and
wherein the step of gripping the end portion of the elastomeric element comprises:
a step of acquisition of the image of the end portion of the elastomeric element on the platform by the first three-dimensional camera;
a step of splitting the image of the end portion of the elastomeric element on the platform into three zones Z1, Z2, Z3;
a step of determining the position of an initial gripping point Ppi of the gripper in the point cloud of the image acquired in the acquisition step by means of a processor;
a step of correcting the initial gripping point Ppi by translating the initial gripping point Ppi by a distance Ra corresponding to a radius of each of the magnetic elements of the gripper along the axis of extension Y1 of the second orthogonal reference frame X1, Y1, Z1 and along a second longitudinal axis X1 of the second orthogonal reference frame perpendicular to the axis of extension Y1 to obtain the gripping point Ppf; and
a step of transmitting the gripping point Ppf to the robotic arm for the purpose of gripping of the end portion of the elastomeric element by the gripper.

33. The method according to claim 32, wherein the anchoring step comprises a step of projecting lasers and a step of acquisition of an image of a laying zone on the outer surface of the drum by a second three-dimensional camera rendering a point cloud of coordinates measured in a reference frame associated with the second three-dimensional camera and having a line of sight oriented toward the drum, the steps of projecting lasers and acquisition of an image being carried out before the step of gripping of the end portion of the elastomeric element by the gripper, the lasers comprising a first fixed vertical laser indicating the center of the drum, a second fixed horizontal laser indicating an azimuth of laying of the elastomeric elements and two variable vertical lateral lasers indicating a longitude of laying.

34. The method according to claim 33, wherein the anchoring step further comprises:
a step of processing the image of the laying zone, during which the lasers and a point cloud rendered by the second three-dimensional camera are detected, pixels associated with the lasers are isolated in the image acquired during the acquisition step, and an intersection pixel pI at an intersection between the second horizontal laser and one of the lateral lasers is detected;
a step of determining the anchoring point P1, P2, P3 of each of the rows of magnetic elements with respect to the intersection point Pi in a plane π of normal \vec{n}_{π}), where a circle fit on the point cloud of one of the lateral lasers is located and as a function of a distance dr between two rows of magnetic elements and a radius Ra of a magnetic element of the gripper; and
a step of transmitting the anchoring points P1, P2, P3 of each of the rows of magnetic elements to a control module for controlling the gripper, configured to separately control the rows of magnetic elements of the gripper.

35. The method according to claim 31 further comprising, prior to the laying step, an elastomeric element feed step during which the end portion of the elastomeric element is laid on the flat receiving surface of the platform of the facility.

36. The method according to claim 31, wherein the sequence of the laying step further comprises a step of supporting the elastomeric element around the drum, a step of cutting the elastomeric element to a desired length, and a step of welding the cut portion of the elastomeric element with the end portion anchored on the outer surface of the drum.
